(19) United States
(12) Patent Application Publication
(10) Pub. No.: US 2002/0163189 A1
(43) Pub. Date: Nov. 7, 2002

(54) Sewage pipe connector for intercepting bad smell

(76) Inventor: Byung Moo Ahn, Kyungsangbuk-do (KR)

Correspondence Address: Ladas & Parry, 26 West 61st Street, New York, NY, 10023, US

(21) Appl. No.: 10/096,515

(22) Filed: Mar. 12, 2002

(30) Foreign Application Priority Data
May 7, 2001 (KR) 2001-24590
Dec. 5, 2001 (KR) 2001-76676

(51) Int. Cl. F16L 43/00

(52) U.S. Cl. 285/179.1; 285/284.1

(57) ABSTRACT

The present invention relates a pipe connector used for connecting sewage discharging pipes. The pipe connector capable of intercepting a bad smell according to the present invention includes an inlet pipe portion engaged to an upper reach pipe for forming an inlet water flow path which receives a sewage from an upper reach pipe, an outlet pipe portion engaged to a lower reach pipe for forming a discharging water flow path which discharges a sewage flown in from the inlet water flow path, a trap portion which forms a connection water flow path including a trap section which forms a water flow path loser than the lowest portion of neighboring water flow paths in which the entire portions of the horizontal cross section of the water flow path contacts in the upper and lower reaches between the inlet pipe portion and outlet pipe portion and guides the sewage from the inlet water flow path to the discharging water flow path, and a dividing pipe portion which forms a dividing path which is upwardly extended from the trap section of the trap portion and divides the water flow path in the trap section in the upward direction.

### BACKGROUND OF THE INVENTION

1. Field of the Invention

The present invention relates to a pipe connector used for connecting a sewage discharging pipe, and in particular to a sewage pipe connector for intercepting a bad smell which includes a bad smell prevention structure capable of preventing a bad smell from being discharged to the outside, separately fabricating a dividing pipe for collecting a deposit such as a sludge various dimensions based on a different height and selecting and engaging the dividing pipes.

2. Description of the Background Art

In a modern society in which a consumption life and various industrial activities are dynamically performed, various wastes which are a by-product of a material civilization activity are produced. Among the above wastes, the amount of a sewage which is continuously produced in a liquid form is large. In the case that the sewage is discharged to the outside or is left alone, a contagious disease may occur or a critical problem may occur in the nature. Therefore, a water supply and discharging facility is provided in all buildings for processing a sewage at the time when the sewage is produced.

In the water discharging facility, a drainpipe for discharging a sewage forms a drain path in a state that the drainpipe is embedded in the water or under the ground for thereby preventing the sewage from being exposed to the outside and guides the sewage to a sewerage or sewage disposal plant or a natural water region. The pipe which is used as the drainpipe is fabricated in a certain length. Therefore, in the case that the water discharging distance is long, multiple pipes are connected using a pipe connector for thereby extending the length of the pipe.

As shown in FIG. 1, the conventional pipe connector is capable of connecting the pipes and removing a sludge which is deposited from the sewage for thereby blocking the pipe.

As shown in FIG. 1, a conventional pipe connector 2 is used for connecting a lower reach pipe 40. As shown in FIG. 2, the conventional pipe connector 2 includes an inlet pipe portion 21 which is engaged with a horizontal upper reach pipe 30 for forming an inlet path 210, an outlet pipe portion 22 which is extended from an end portion of the connection portion of the upper reach pipe 30 in a vertical and downward direction and is engaged with the vertical lower reach pipe 40 and forms an outlet water path 220, and three integral pipe portions 21, 22 and 23 formed of a dividing pipe portion 23 extended in a vertical direction between the inlet pipe portion 21 and the outlet pipe portion 22 for thereby forming a dividing path 230 in a vertical direction. A filtering portion 24 is extended in a plate shape at a slanted angle in the flow direction of the sewage from the bottom of the inlet pipe portion 21 to the upper portion for filtering a solid waste such as a sludge included in the sewage at the end of the lower reach of the inlet pipe portion 21.

In the above construction, the dividing path 230 formed by the dividing pipe portion 23 is used as a water flow path for receiving a sewage which is produced in another place or collecting a sludge filtered by the filtering portion 24. A pipe or a water discharging portion is engaged to the upper portion of the dividing pipe portion 23 for guiding the sewage which is produced in other places. In the case that a pipe is not additionally engaged, a lid 25 is thread-engaged to the upper portion of the dividing pipe portion 23 for preventing a sewage or bad smell from being discharged to the outside through the dividing path 230 of the dividing pipe portion 23.

In the conventional pipe connector 2, the upper reach pipe 30 and the lower reach pipe 40 are connected by the inlet pipe portion 21 and the outlet pipe portion 22, so that the sewage flown into the inlet pipe portion 21 is guided to the lower reach pipe 40 through the outlet pipe portion 22. In addition, in the case that other pipe or water discharging portion is installed in the dividing pipe portion 23, the sewage is flown in through the pipe or the water discharging portion and is mixed with the sewage from the lower reach pipe 40 for thereby discharging to the outside. In the above sewage induction process, a sludge is filtered by the filtering unit 24 installed at the end portion of the inlet pipe portion 21 and is collected in the dividing path 230 for thereby preventing a blocking of the pipe due to the sludge.

In the conventional pipe connector 2, since the upper space above the water of the sewage which flows along the inlet pipe portion 21 is always connected with the dividing potion 23, a bad smell produced in the sewage and filled in the interior of the dividing pipe portion 23 may be discharged to the outside because the bad smell is prevented by only the lid 25. In particular, when opening the lid 25 in order to collect the sludge filtered by the filtering portion 24, as shown in FIG. 2, the bad smell which is produced in the sewage and is filled in the dividing pipe portion 23 and the upper and lower reach pipes 30 and 40 may be temporarily discharged through the dividing path 230 of the dividing pipe portion 23 in the arrow direction, so that it is impossible to remove the sludge. In addition, since the bad smell which is harmful to the health of a human is quickly spread to the outside for thereby polluting the neighboring area in short time. In addition, in the conventional pipe connector 2, the sludge filtered by the filtering portion 24 is removed using a hand or a certain tool multiple times through the dividing path 230 of a narrow dividing pipe portion 23. Therefore, it is very hard to remove the sludge and is insanitary.

The conventional pipe connector 2 is integrally formed of the dividing pipe portion 23, the inlet pipe portion 21 and the outlet pipe portion 22 which are fabricated based on the casting mold method. Therefore, it is impossible to adjust the upper and lower lengths of the dividing pipe portion 23, so that in the case that the upper and lower length of the dividing pipe portion 23 is different from the pipe embedding depth, it is impossible to install. Therefore, in the conventional pipe connector 2, the dividing pipe portions 23 are fabricated based on different upper and lower lengths for overcoming the problem that the pipe embedding depths are different.

### SUMMARY OF THE INVENTION

Accordingly, it is an object of the present invention to provide a sewage pipe connector for intercepting a bad smell which overcomes the problems encountered in the conventional art.

It is another object of the present invention to provide a sewage pipe connector for intercepting a bad smell which includes a bad smell intercepting structure capable of preventing a bad smell produced in a sewage from being discharged to the outside and selectively engaging a vertical pipe portion having a proper dimension with respect to an embedding depth of a water discharging pipe wherein the vertical pipe portions are fabricated in a separate state in multiple dimensions.

In order to achieve the above objects, there is provided a sewage pipe connector for intercepting a bad smell which includes an inlet pipe portion engaged to an upper reach pipe for forming an inlet water flow path which receives a sewage from an upper reach pipe, an outlet pipe portion engaged to a lower reach pipe for forming a discharging water flow path which discharges a sewage flown in from the inlet water flow path, a trap portion which forms a connection water flow path including a trap section which forms a water flow path loser than the lowest portion of neighboring water flow paths in which the entire portions of the horizontal cross section of the water flow path contacts in the upper and lower reaches between the inlet pipe portion and outlet pipe portion and guides the sewage from the inlet water flow path to the discharging water flow path, and a dividing pipe portion which forms a dividing path which is upwardly extended from the trap section of the trap portion and divides the water flow path in the trap section in the upward direction.

There is further provided a dividing pipe engaged to a front end of the dividing pipe portion and upwardly extending the dividing path.

There is further provided a deposition pipe portion which is downwardly extended from the trap portion and forms a deposition compartment in which a deposit deposited from a sewage which flows through the trap portion is gathered.

There is further provided a collecting container detachably disposed in the deposition compartment of the deposition pipe portion for collecting and removing the deposit.

There is further provided a lid detachably engaged to a front end of the dividing pipe for thereby sealing the dividing path.

There is further provided a filtering net member detachably disposed at an entrance of the outlet pipe portion contacting with the trap portion for thereby filtering a solid thing from a sewage which flows from the trap portion to the outlet pipe portion.

### BRIEF DESCRIPTION OF THE DRAWINGS

The present invention will become better understood with reference to the accompanying drawings which are given only by way of illustration and thus are not limitative of the present invention, wherein;

FIG. 1 is a perspective view illustrating a pipe engaging state based on a conventional pipe connector;

FIG. 2 is a cross sectional view illustrating a pipe connecting structure based on a conventional pipe connector;

FIG. 3 is a view illustrating an assembled state of a pipe connected by a pipe connector capable of intercepting a bad smell according to an embodiment of the present invention;

FIG. 4 is a cross sectional view illustrating an embedded sewage pipe connected by a pipe connector capable of intercepting a bad smell according to an embodiment of the present invention;

FIG. 5 is a cross sectional view illustrating an embedded sewage pipe connected by a pipe connector capable of intercepting a bad smell according to another embodiment of the present invention; and

FIG. 6 is a perspective view illustrating a sludge removing process from a pipe connected by a pipe connector capable of intercepting a bad smell according to another embodiment of the present invention.

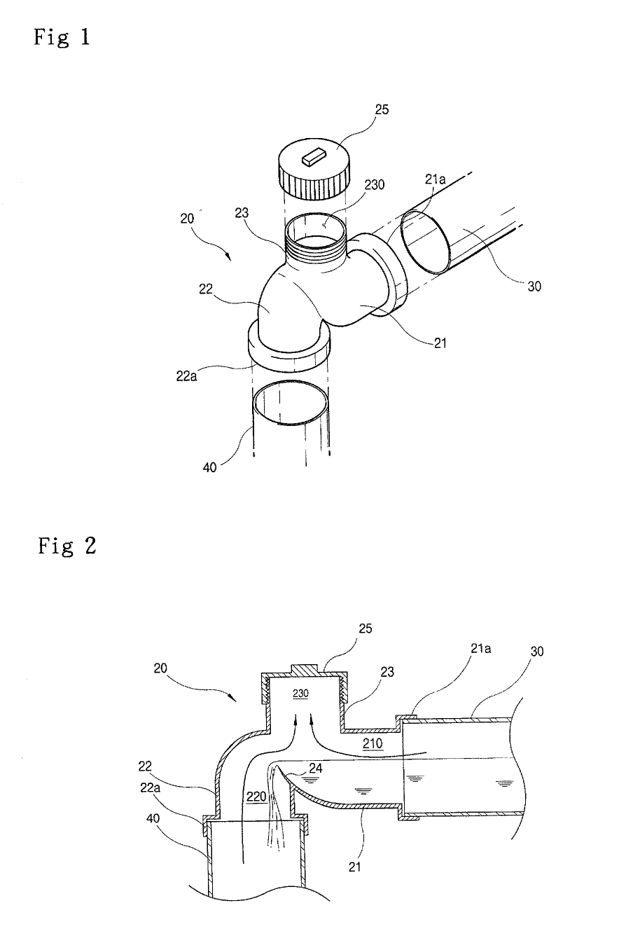

### DETAILED DESCRIPTION OF THE PREFERRED EMBODIMENTS

The embodiments of the apparatus for monitoring a radio frequency of a repeater according to the present invention will be described with reference to the accompanying drawings.

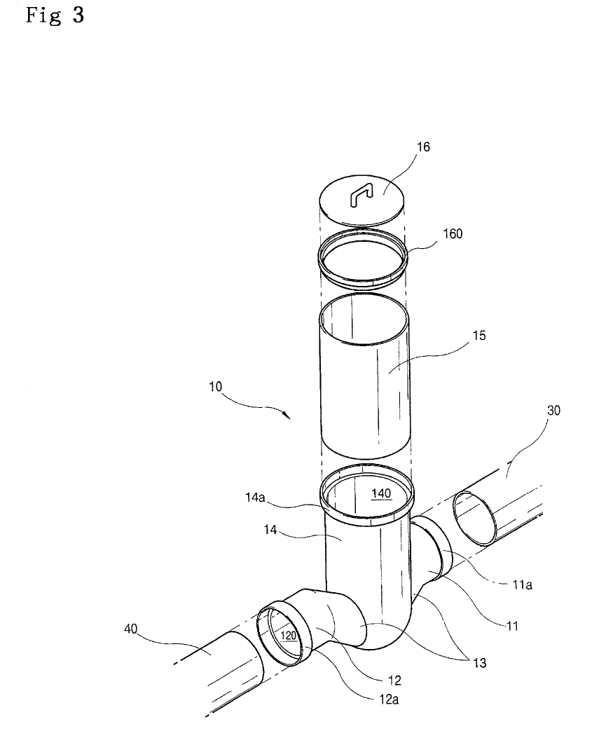

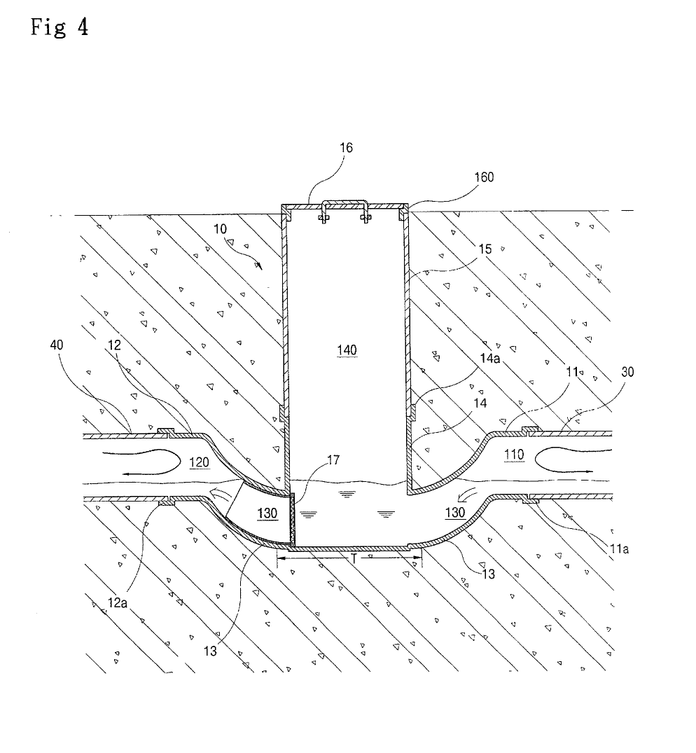

FIG. 3 is a view illustrating an assembled state of a pipe connected by a pipe connector capable of intercepting a bad smell according to an embodiment of the present invention, and FIG. 4 is a cross sectional view illustrating an embedded sewage pipe connected by a pipe connector capable of intercepting a bad smell according to an embodiment of the present invention.

A pipe connector 10 capable of intercepting a bad smell includes an inlet pipe portion 11 and an outlet pipe portion 12 which are used for connecting two pipes, namely, upper and lower reach pipes 30 and 40 which are arrange din parallel, a trap portion 13 connecting the inlet pipe portion and the outlet pipe portion 12, and a dividing pipe portion 14 upwardly extended from the center of the trap portion 13.

The inlet pipe portion 11 and the outlet pipe portion 12 are arranged in opposite directions. The front end portions of the inlet pipe portion 11 and the outlet pipe portion 12 are connected with the upper reach pipe 30 and the lower reach pipe 40 for thereby forming an inlet water flow path 110 and an outlet water flow path 120 capable of receiving and discharging the sewage. Engaging rims 11a and 12a each having an extended diameter are engaged to the end portions o the inlet pipe portion 11 and the outlet pipe portion 12 which are inserted onto the upper reach pipe 30 and the lower each pipe 40, respectively.

The trap portion 13 forms a connection water flow path 130 capable of guiding the sewage flown into the inlet pipe portion 11 to the outlet pipe portion 12 between the inlet pipe portion 11 and the outlet pipe portion 12. A part of the sewage which is flown in through the inlet water flow path 110 and is discharged to the outlet water flow path 120 is stored in the trap section T in such a manner that the cross section portion of the water flow path in the connection water flow path 130 is lower than the height of the bottom of the neighboring upper and lower reach water flow paths(for example, the inlet water flow path 110 and the outlet water flow path 120). A filtering net member 17 is installed at the entrance of the outlet water flow path 120 of the outlet pipe portion 12 neighboring with the trap portion 13 for filtering the sludge from the sewage from the trap portion 13 to the outlet water flow path 120.

The trap portion 13 intercepts the bad smell in the upper and lower reach pipes 30 and 40 in such a manner that the sewage flown in through the inlet pipe portion 11 is guided to the outlet pipe portion 12, a part of the sewage is stored in the trap section T of the connection water flow path 130 for thereby disconnecting the upper and lower reach portions of the trap section T for thereby preventing a flow of the gas between the upper and lower reach pipes 30 and 40. The connection water flow path 130 is formed in a portion lower than the inlet water flow path 110 of the inlet pipe portion 11 and the outlet water flow path 120 of the outlet pipe portion 12, and the sewage is filtered by the filtering net member 17 installed at the entrance of the outlet pipe portion 12, and the deposits which is deposited due to a larger weight compared to the deposit is gathered on the floor of the connection water flow path 130 for thereby removing the deposit through the dividing path of the dividing pipe 15.

The dividing pipe portion 14 is formed of a hollow pipe extended from the trap section T of the trap portion 13 in a vertical direction. An engaging rim 14a which has an extended diameter is formed on the front end of the same for thereby being inserted by the dividing pipe 15 or the water discharging portion. The dividing pipe portion 14 forms a dividing flow path 140 which opens the connection water flow path in the upward direction in the trap portion 13. The dividing path 140 is used for receiving a sewage or removing a deposit such as a sludge deposited on the trap portion 13. Namely, in the case that the dividing pipe 15, the pipe or the water discharging portion is installed at the front end of the same, the sewage is guided to the trap portion 13 based on the dividing pipe 15, and the sludge is discharged to the outlet pipe portion 12 together with the sewage flown in through the inlet pipe portion 11. In addition, it is used for removing the sludge gathered in the trap section T of the trap portion 13. In the case that the dividing path 140 I used for only removing the sludge, the separable lid 16 is engaged to the front end of the dividing pipe portion 14(or the dividing pipe 15) based on the disposed engaging rim 160 for thereby implementing a sealed state.

The dividing pipe 15 is engaged to the front end of the dividing pipe portion 14 and extends the dividing path 140 formed by the dividing pipe portion 14 in the upward direction and is fabricated in various dimensions. The length of the dividing path 140 is adjustable based on the selection of the dimension. As shown in FIG. 4, in the case that the pipe connector capable of intercepting a bad smell according to the present invention is used for connecting the pipes which are embedded under the ground, the dividing pipe 15 having a certain dimension is selected based on the embedding depth of the pipe and is engaged to the dividing pipe portion 14, so that the entrance of the dividing path 140 contacts with the surface of the ground. As the dividing pipe 15 is separately fabricated, the height of the dividing path 140 of the pipe connector capable of intercepting a bad smell according to the present invention is adjusted by changing the dividing pipe 15. Therefore, it is possible to overcome the problems of the conventional art in which the entire elements of the pipe connector 10 are fabricated in various dimensions for obtaining a difference in the height of the dividing path 140.

The pipe connector 10 capable of intercepting a bad smell according to the present invention, the upper and lower reach pipes 30 and 40 are connected for thereby guiding the sewage of the upper reach pipe 30 to the lower reach pipe 40. In the above operation, the sewage which is always filled in the trap section T of the trap portion 13 blocks the inlet and outlet water flow paths 110 and 120 and the dividing path 130, so that it is possible to prevent the bad smell filled in the upper and lower reach pipes 30 and 40 from being spread to the outside through the dividing path 140. In addition, the sludge and the like are filtered by the filtering net member 17 and its weight and are gathered in the trap portion 13 which is formed in a lower portion, and the gathered deposit is removed through the dividing path for thereby preventing a pipe blocking phenomenon due to the sludge and the like.

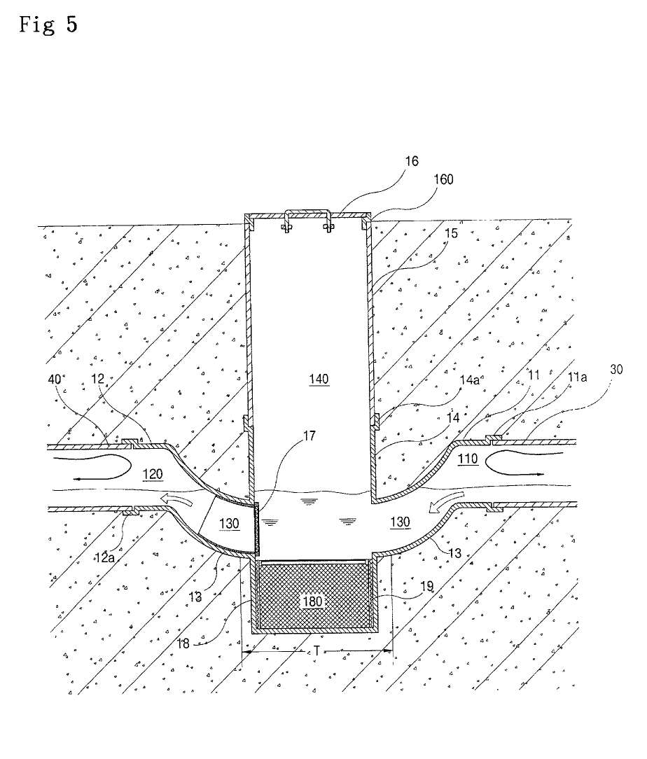

FIG. 5 is a cross sectional view illustrating a sewage pipe which is assembled and embedded based on a pipe connector capable of intercepting a bad smell according to another embodiment of the present invention.

As shown therein, the pipe connector capable of intercepting a bad smell includes an inlet pipe portion 11 and an outlet pipe portion 12 which are opposite each other on the same axis in the same manner as the first embodiment of the present invention, a trap portion 13 for connecting the inlet pipe portion 11 and the outlet pipe portion 12 between the inlet pipe potion 11 and the outlet pipe portion 12, a dividing pipe portion 14 which is upwardly extended in the trap section T of the trap portion 13, and a dividing pipe 15 engaged to the upper portion of the dividing pipe portion 14. There are further provided a deposit pipe portion 18 which is downwardly extended from the trap portion 13 from the lower side of the dividing pipe 15 for thereby forming a deposition compartment 180 therein, and a net structure collecting container 19 disposed in the deposition compartment 180 of the deposition pipe portion 18 in such a manner that the deposit is removed through the dividing path by opening the lid 16 engaged to the upper portion of the dividing pipe 15(or the dividing pipe portion 14).

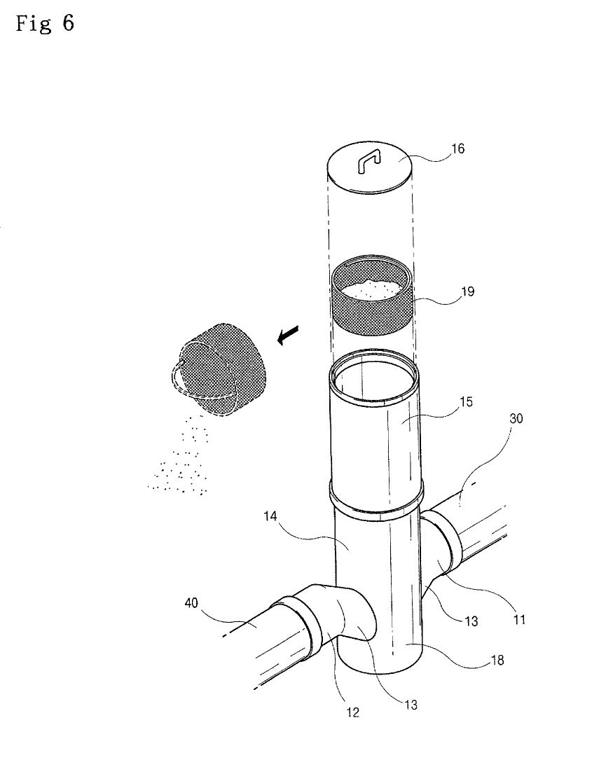

In the pipe connector capable of intercepting a bad smell according to another embodiment of the present invention, since the sludge deposited in the trap 13 is gathered in the deposition compartment 180 and does not prevent the flow of the sewage for thereby increasing a discharging efficiency. Since the capacity of the deposit filtered by the trap portion 13 is large, a removing period may be increased. In addition, the deposit such as a sludge, etc. is gathered in the collecting container, as shown in FIG. 6, it is possible to remove the sludge in one time, so that it is easy to remove the deposit.

As described above, the pipe connector capable of intercepting a bad smell is directed to preventing a bad smell in the upper and lower reach pipes from being spread to the outside using a sewage which is always filled in the interior of the trap portion during the sewage discharging process.

In addition, since it is possible to filter the sludge included in the sewage in the trap portion installed in a lower portion and remove the same for thereby preventing a discharging efficiency decrease due to the sludge and the pipe blocking phenomenon.

Furthermore, in the pipe connector capable of blocking a bad smell according to the present invention, the dividing pipes which determine the height of the dividing path are separately fabricated and then assembled, so that it is possible to adjust the height of the dividing path based on the selection of the dividing pipe engaged to the dividing pipe portion. Therefore, it is possible to overcome the problems of the conventional art in which the pipe connector is fabricated in various dimensions for obtaining different heights of the dividing path due to the embedding depth differences of the pipes.

As the present invention may be embodied in several forms without departing from the spirit or essential characteristics thereof, it should also be understood that the above-described embodiments are not limited by any of the details of the foregoing description, unless otherwise specified, but rather should be construed broadly within its spirit and scope as defined in the appended claims, and therefore all changes and modifications that fall within the meets and bounds of the claims, or equivalences of such meets and bounds are therefore intended to be embraced by the appended claims.

What is claimed is:

1. A pipe connector capable of intercepting a bad smell, comprising:
an inlet pipe portion engaged to an upper reach pipe for forming an inlet water flow path which receives a sewage from an upper reach pipe;
an outlet pipe portion engaged to a lower reach pipe for forming a discharging water flow path which discharges a sewage flown in from the inlet water flow path;
a trap portion which forms a connection water flow path including a trap section which forms a water flow path loser than the lowest portion of neighboring water flow paths in which the entire portions of the horizontal cross section of the water flow path contacts in the upper and lower reaches between the inlet pipe portion and outlet pipe portion and guides the sewage from the inlet water flow path to the discharging water flow path; and
a dividing pipe portion which forms a dividing path which is upwardly extended from the trap section of the trap portion and divides the water flow path in the trap section in the upward direction.

2. The connector of claim 1, further comprising:
a dividing pipe engaged to a front end of the dividing pipe portion and upwardly extending the dividing path.

3. The connector of either claim 1 or claim 2, further comprising:
a deposition pipe portion which is downwardly extended from the trap portion and forms a deposition compartment in which a deposit deposited from a sewage which flows through the trap portion is gathered.

4. The connector of claim 3, further comprising:
a collecting container detachably disposed in the deposition compartment of the deposition pipe portion for collecting and removing the deposit.

5. The connector of either claim 1 or claim 2, further comprising:
a lid detachably engaged to a front end of the dividing pipe for thereby sealing the dividing path.

6. The connector of either claim 1 or claim 2, further comprising:
a filtering net member detachably disposed at an entrance of the outlet pipe portion contacting with the trap portion for thereby filtering a solid thing from a sewage which flows from the trap portion to the outlet pipe portion.
